(19) United States
(12) Patent Application Publication
(10) Pub. No.: US 2026/0252829 A1
(43) Pub. Date: Aug. 27, 2026

(54) DYNAMIC SHORT RANGE DEVICE (SRD) POWER TRANSMISSION

(71) Applicant: QUALCOMM Incorporated, San Diego, CA (US)

(72) Inventors: Kiran PATIL, San Diego, CA (US); Bhupesh Manoharlal UMATT, San Diego, CA (US); Scott HOOVER, Del Mar, CA (US); Ajay Vignesh JAYAPRAKASH, San Diego, CA (US); Sayak SAHA, San Diego, CA (US); Vishal DALMIYA, San Diego, CA (US); Chetan Jagdeesh BHARADWAJ, Erie, CO (US); Sheng-Yuan TU, San Diego, CA (US); Qi FU, San Diego, CA (US)

(21) Appl. No.: 19/064,408

(22) Filed: Feb. 26, 2025

(51) Int. Cl. G06K 7/10

(52) U.S. Cl. CPC G06K 7/10217

(57) ABSTRACT

Systems and techniques are described herein for wireless communication. For example, a computing device can transmit, at a first transmission power level of a short range device (SRD), a first sequence of commands to a first plurality of Radio Frequency Identification (RFID) tags to inventory the first plurality of RFID tags; adjust the first transmission power level of the SRD to a second transmission power level; and transmit, at the second transmission power level of the SRD, a second sequence of commands to a second plurality of RFID tags to inventory the second plurality of RFID tags.

### FIELD

The present disclosure generally relates to wireless communication using short range communication technologies (e.g., radio frequency a Radio Frequency identification (RFID) or other short range wireless communications). For example, aspects of the present disclosure relate to systems and techniques for dynamic SRD power transmission.

### BACKGROUND

Wireless communication technologies are generally classified based on a communication distance range of the technologies. For example, wireless communication technologies can be classified as short-range or long-range wireless communication technologies. Short-range wireless communication technologies generally refer to wireless communication technologies with transmit powers and frequencies enabling wireless communication limited to within roughly thirty meters. Long-range wireless communication technologies can encompass wireless communication technologies enabling communication over longer distances (e.g., more than thirty meters). Radio Frequency Identification (RFID) systems are generally classified as short range wireless communication. RFID technologies provide wireless communication between a reader (e.g., RFID reader device) and a tag or transponder (e.g., RFID tag). RFID systems are generally used for identifying and tracking objects in an environment. For example, RFID tags can be applied to (e.g., affixed as a label) or included in objects to enable an RFID reader to identify and track the objects. One example use of RFID systems can include using RFID tags associated with packages in transit to track delivery of packages.

The environments in which RFID readers are generally used are oftentimes larger than the maximum communication range of the RFID readers. For example, many RFID readers are used in environments such as in a warehouse or distribution center to track stock or packages in transit. RFID readers are often mobile devices (or included in a mobile device such as a smartphone, tablet, etc.). Power consumption, as with any mobile device, is a concern for RFID readers because the amount of power consumed by the RFID reader impacts the RFID reader usability.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present concepts relating to one or more aspects relating to the mechanisms disclosed herein in a simplified form to precede the detailed description presented below.

In some aspects, an apparatus for wireless communications is provided. The apparatus includes at least one memory and at least one processor coupled to the at least one memory and configured to: transmit, at a first transmission power level of a short range device (SRD), a first sequence of commands to a first plurality of tags to inventory the first plurality of tags; adjust the first transmission power level of the SRD to a second transmission power level; and transmit, at the second transmission power level of the SRD, a second sequence of commands to a second plurality of tags to inventory the second plurality of tags.

In some aspects, a method for wireless communications is provided. The method includes: transmitting, at a first transmission power level of a short range device (SRD), a first sequence of commands to a first plurality of tags to inventory the first plurality of tags; adjusting the first transmission power level of the SRD to a second transmission power level; and transmitting, at the second transmission power level of the SRD, a second sequence of commands to a second plurality of tags to inventory the second plurality of tags.

In some aspects, a non-transitory computer-readable medium is provided having stored thereon instructions that, when executed by at least one processor, cause the at least one processor to: transmit, at a first transmission power level of a short range device (SRD), a first sequence of commands to a first plurality of tags to inventory the first plurality of tags; adjust the first transmission power level of the SRD to a second transmission power level; and transmit, at the second transmission power level of the SRD, a second sequence of commands to a second plurality of tags to inventory the second plurality of tags.

In some aspects, an apparatus for wireless communication is provided. The apparatus can include: means for transmitting, at a first transmission power level of a short range device (SRD), a first sequence of commands to a first plurality of tags to inventory the first plurality of tags; means for adjusting the first transmission power level of the SRD to a second transmission power level; and means for transmitting, at the second transmission power level of the SRD, a second sequence of commands to a second plurality of tags to inventory the second plurality of tags.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

FIG. 1A is a diagram illustrating example components of a device, in accordance with aspects of the present disclosure.

FIG. 1B is a diagram illustrating an example of a radio frequency (RF) energy harvesting device, in accordance with aspects of the disclosure.

FIG. 2 is a diagram illustrating an example of a radio frequency identification (RFID) system as an example of a short range wireless communication system, in accordance with aspects of the present disclosure.

FIG. 3 is a block diagram illustrating an example inventorying process over a period of time, in accordance with aspects of the present disclosure.

FIG. 4A is a block diagram illustrating an example inventorying process with dynamic RFID transmission power over a period of time, in accordance with aspects of the present disclosure.

FIG. 4B is a block diagram illustrating another example inventorying process with dynamic RFID transmission power over a period of time, in accordance with aspects of the present disclosure.

FIG. 5 is a block diagram illustrating example transmission power levels, in accordance with aspects of the present disclosure.

FIG. 6 is a block diagram illustrating an example of dynamic RFID transmission power levels) based on changes in RFID reader location, in accordance with aspects of the present disclosure.

FIG. 7 is a block diagram illustrating an example of wireless communication range of a mobile RFID reader, in accordance with aspects of the present disclosure.

FIG. 8 is a flowchart diagram illustrating an example of a process for wireless communications, in accordance with aspects of the present disclosure.

FIG. 9 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

Wireless communication technologies can generally be classified based on a distance range associated with the technologies. For example, wireless communication technologies can be short-range or long-range communication technologies. Short-range wireless communication technologies generally refer to wireless communication technologies with transmit powers and frequencies enabling wireless communication within roughly thirty meters. Long-range wireless communication technologies can encompass wireless communication technologies enabling communication over longer distances (e.g., more than thirty meters).

Radio Frequency Identification (RFID) systems are generally classified as short range wireless communication. Other types of short range wireless communication systems can communicate using other types of short range communications, such as near field communication (NFC), Bluetooth™, Wi-Fi, SRD860, or other short range communication technology. Short range communications systems can include one or more short range devices (SRDs) and one or more passive devices (e.g., energy harvesting devices, tags, etc.). For example, an SRD can use energy (e.g., RF energy) emitted by itself, and/or by other sources, to excite or charge a receiver, such as a tag (e.g., an RFID tag or other type of tag, etc. An RFID reader device is an example of an SRD. Examples of passive devices (e.g., energy harvesting devices) of SRD systems include electronic tags or other devices. The one or more SRDs and/or passive devices can be configured to communicate using one or more short range communications protocols (e.g., NFC, Bluetooth™, Wi-Fi, SRD860, etc.). Such short range communications technologies (e.g., RFID technologies, etc.) can provide wireless communication between an SRD (e.g., an RFID reader device) and a tag or transponder (e.g., RFID tag). RFID systems and other short range communications systems can be used for identifying and tracking objects in an environment. For example, RFID tags can be applied to (e.g., affixed as a label) or included in objects to enable an RFID reader to identify and track the objects. One example use of RFID systems can include using an RFID reader and RFID tags associated with packages in transit to track delivery of packages. While examples described herein use RFID systems for illustrative purposes, systems other than RFID systems can provide short range wireless communication according to aspects described herein.

RFID tags generally include data storage and an antenna. For example, the data storage can store information corresponding to an item (e.g., the item with the RFID included or affixed). In such an example, the information can include an identifier of the item such as a name, an electronic product code (EPC), a serial number, manufacturer, etc. The antenna can enable wireless communication (transmission of commands and data) from the RFID tag, or for the RFID tag to be read by an RFID reader. RFID tags can be powered by the RFID reader. For example, an interrogating signal from the RFID reader (e.g., a signal from the RFID reader to read an RFID tag or request information from an RFID tag) can be used to power the RFID tag.

Long range wireless communication can be achieved using telecommunications networks, such as 5G networks. As telecommunications networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc. In some aspects, passive IoT devices may also be referred to as “ambient IoT devices” or simply as “passive devices”. For example, an ambient IoT device may be an IoT device that can perform ambient energy harvesting. An ambient IoT device may also be referred to as an ambient energy harvesting device. As used herein, the term “ambient IoT devices” may refer to active IoT devices, passive IoT devices, and/or semi-passive IoT devices.

In some examples, ambient IoT devices (e.g., active IoT devices, passive IoT devices, semi-passive IoT devices, etc.) are relatively low-cost devices that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. (e.g., to monitor, track, and locate items associated with the passive IoT devices). Passive and semi-passive IoT devices can include one or more sensors, a processor or micro-controller, and an energy harvester for generating electrical power from incident downlink radio frequency (RF) signals received at the passive or semi-passive IoT device. Energy harvesting devices can be deployed at large scales, based on the simplification in their manufacture and deployment associated with implementing wireless energy harvesting.

Currently, passive devices, such as in the form of electronic tags (e.g., Radio Frequency Identification (RFID) tags), are a rapidly growing technology impacting many industries, due to their economic potential for inventory and/or asset management inside and outside warehouses, IoT devices, sustainable sensor networks in factories and/or agriculture, and smart home usage. Electronic tags may include small transponders, or tags, that emit an information-bearing signal after receiving a signal.

Energy harvesting devices (e.g., electronic tags such as RFID tags) can harvest energy over-the-air to power their transmission and reception circuitry. For example, in some cases, energy harvesting devices can harvest energy from ambient downlink RF signals (e.g., including dedicated downlink RF signals for energy harvesting and various other downlink RF signals that are not dedicated energy harvesting signals). Based on harvesting energy from incident downlink radio frequency (RF) signals (e.g., transmitted by a network device, such as a reader device or an interrogator), ambient energy harvesting devices (e.g., passive IoT devices, which may be in the form of electronic tags such as RFID tags) may be provided without an energy storage element and/or can be provided with a relatively small energy storage element (e.g., battery, capacitor, etc.). For example, energy harvesting devices (e.g., electronic tags) can operate without a battery at a low operating expense (OPEX), with a low maintenance cost, and with a long-life cycle. Ambient energy harvesting devices provided without an energy storage element may include passive IoT devices. Ambient energy harvesting devices provided with a relatively small energy storage element may include semi-passive IoT devices. Ambient energy harvesting devices that are provided with an energy storage element may include active IoT devices. Energy harvesting devices can be deployed at large scales, based on the simplification in their manufacture and deployment associated with implementing wireless energy harvesting.

In a wireless communication environment, a device (e.g., such as a reader device or interrogator) can be used to transmit downlink RF signals to energy harvesting devices. In one illustrative example, a reader device can read and/or write information stored on energy harvesting IoT devices (e.g., electronic tags, which may each be associated with a respective item) by transmitting the downlink RF signal. The downlink RF signal can provide energy to an energy harvesting IoT device. The energy harvesting IoT device can transmit (e.g., based on reflecting or backscattering a portion of the incident downlink RF signal) a response signal (e.g., an information-bearing uplink signal) back to the reader device, after the energy harvesting IoT device is sufficiently energized based on the downlink RF signal. The reader device can read the signal transmitted by an energy harvesting IoT device to decode the information transmitted by the IoT device (e.g., such as sensor information collected by one or more sensors included in the IoT device, etc.).

In some cases, an energy harvesting device can use the same antenna for energy harvesting and communications. For example, an energy harvesting device can use the same antenna to perform energy harvesting and backscatter communications, where the energy harvesting and the backscatter communications are based on the same downlink RF signal. In some examples, an energy harvesting device can include a first antenna used for energy harvesting and a second antenna used for communications, where the first antenna is different from the second antenna. For instance, an ambient IoT device can use the first antenna to perform energy harvesting and can use the second antenna to perform communication (e.g., transmitting and/or receiving).

A backscatter transmitter of an energy harvesting device can generate and transmit an uplink signal (also referred to as a backscatter signal) by reflecting and backscatter modulating an incident downlink signal using the first antenna. In some examples, an ambient IoT device can use a backscatter transmitter that is the same as or similar to a backscatter transmitter utilized by a passive or semi-passive IoT device, as described above. An active transmitter can use a battery or other energy storage element included in the ambient IoT device to generate and transmit an uplink signal, using an antenna that is different from the first antenna associated with the backscatter transmitter (e.g., a second antenna). To transmit an uplink signal, the backscatter transmitter of an ambient IoT device must first receive a downlink signal that can be reflected and backscatter modulated. For example, the backscatter transmitter may be unable to transmit an uplink signal unless or until a continuous sine wave is received as a downlink signal from a reader device or other energy source network device. The active transmitter of an ambient IoT device can perform uplink communication that is triggered by the ambient IoT device (e.g., without dependence on first receiving a downlink signal). In some examples, ambient IoT devices may include a small battery or energy storage element and may be unable to sustain longer periods of uplink communication using the active transmitter of the ambient IoT device. For example, active transmission by an ambient IoT device may quickly deplete the onboard battery or other energy storage element(s) included in the ambient IoT device.

In some examples, for a given downlink signal with a given input RF power received at an ambient energy harvesting device, a first portion of the input RF power is provided to the device's energy harvester (e.g., with a percentage being converted to useful electrical power based on the conversion efficiency of the harvester, and the remaining percentage dissipated as heat, etc.). A remaining, second portion of the input RF power is available for use in the backscattered uplink transmission (e.g., the second portion of the input power is reflected and modulated with the uplink communication).

An energy harvesting tag (EH-tag) system is an ambient IoT system. The system generally includes an energizer (e.g., a reader device or interrogator) and an electronic tag (e.g., which is a low cost device). An electronic tag does not include a battery and relies on wireless power transfer (WPT) from over-the-air to perform energy harvesting (e.g., to harvest energy from the wireless signals transmitted from the energizer). The energizer can send a downlink wireless power transfer waveform (e.g., including a continuous waveform (CW)) to the electronic tags.

An example of an energy harvesting device (e.g., tag) is an RFID tag configured to communicate using RFID communications. RFID systems are generally classified as short range wireless communication. RFID technologies provide wireless transfer of data between a reader (e.g., RFID reader device) and a tag or transponder (e.g., RFID tag). As noted previously, RFID systems can be used for identifying, inventorying, and tracking information associated with tagged physical objects (e.g., a box in a warehouse, items in a store, etc.).

RFID systems can be used for wireless communication between a reader device (e.g., RFID reader or other SRD) and one or more tags or transponders (e.g., RFID tags). An RFID reader may also be referred to as an “SRD,” an “RFID interrogator,” an “RFID scanner,” and/or an “energizer.” RFID systems can be used to identify and/or track various items that are associated with one or more RFID tags (e.g., various items to which one or more RFID tags are attached). RFID systems can read and/or write information to and/or from (respectively) RFID tags, based on respective wireless communications between an RFID reader and the RFID tags.

For example, an RFID reader (e.g., energizer) can be used to interrogate one or more RFID tags to obtain information of the nearby items that are within communication range of the RFID reader and the interrogation signal. The RFID reader (e.g., energizer) can transmit an RF signal to perform the energizing and interrogating of the RFID tags. An RFID tag that receives the interrogating RF wave can respond by backscattering (e.g., reflecting back) and/or transmitting another RF wave, as previously described. An RFID tag may generate the responsive RF wave originally (e.g., in examples where the RFID tag is an active or semi-active tag). An RFID tag may generate the responsive RF wave passively, for instance by reflecting back a portion of the interrogating RFID wave using a backscatter process (e.g., in examples where the RFID tag is a passive tag). The responsive RF wave can be referred to as the immediate RFID tag reply. The timing of the responsive RF wave can be tracked by the RFID reader during inventorying. For example, the RFID reader can include a threshold time for when the RFID reader anticipates the responsive RF wave. The threshold time can represent a time from interrogator (e.g., the RFID reader) transmission to the RFID tag (e.g., T1 of the Electronic Product Code (EPC) Generation 2 (e.g., Gen2) standards). T1 can represent a threshold time period or range of time during which the RFID anticipates a response (e.g., the responsive RFID wave) from the RFID tag. When the RFID reader does not receive a response from the RFID reader (e.g., the responsive RFID wave) within the T1 time period, the RFID reader can proceed with transmitting commands (e.g., inventorying commands, access commands, and/or other types of commands) in the inventorying process such as transmitting a query command for subsequent RFID tags, performing duplicative actions such as retransmitting a message to the RFID tag, terminating the inventorying process, etc.

An RFID tag attached to a respective item, or attached to a group of items, can store corresponding information thereof. For example, an RFID tag can include a data storage element that stores information corresponding to the item(s) to which the RFID is attached and associated. For instance, RFID tag information can include one or more of a product name, a serial number, product information, a manufacturer, etc. In some examples, the RFID tag can store identification information that is directly indicative of a tagged item, product, object, etc. For instance, an RFID tag can store identification information such as a unique product serial number, etc. In some examples, the RFID tag does not store product or item identification information directly, and stores a unique RFID tag serial number or identification number which may be externally mapped to various item identification information such as product serial numbers, product names, product SKUs, etc.

An RFID reader (e.g., energizer) can transmit an RF signal configured to cause the RFID tags to transmit at least a portion of their respective identification information. The RFID reader can receive (e.g., scan) the identification information transmitted by the one or more RFID tags energized by the RFID reader and can use the identification information to track inventory of tagged items or products that are within range of the RF signal of the RFID reader (e.g., nearby such as within 30 meters). The timing of responses can be tracked by the RFID reader during inventorying. For example, the RFID reader can include a threshold time for when the RFID reader anticipates a response from the RFID tags. In some examples, the response can be a separate response from the responsive RF signal. The threshold time can represent a time from RFID tag response interrogator (e.g., the RFID reader) transmission of a subsequent command or RFID reader response to the RFID tag (e.g., T2 of the EPC Gen2 standards).

RFID readers can be configured to read hundreds of RFID tags per second, based on the respective RFID tags responding to an interrogation signal from the RFID reader using a corresponding time slot determined for the respective RFID tag. The time slot used by an RFID tag can be assigned by the RFID reader or can be determined by the RFID tags. For example, RFID tags can respond to an interrogation signal based on randomly choosing a time slot within a configured time window for response. In some cases, an anti-collision algorithm can be used to divide a time window into a plurality of discrete time slots for RFID tags responses, within which each RFID tag can randomly choose or be assigned a particular time slot. Each RFID tag transmits its identification information back to the reader in the corresponding or allocated time slot for the RFID tag. Restricting each RFID tag to a particular time slot reduces the chances of a collision occurring when two or more RFID tags attempt to transmit during the same time slot. If a collision occurs, the multiple RFID tags attempting to transmit during the same time slot are not successfully read by the RFID reader and may be configured to select new time slots and retransmit. The RFID reader can generate and update a slot counter to track an expected number of RFID tags in an environment within range of the RFID reader. When the slot counter reaches a predetermined value (e.g., 0) and the RFID reader does not receive additional responses from RFID tags, the RFID reader can determine that all RFID tags within range of the RFID reader have been inventoried.

Inventorying multiple RFID tags can be a time intensive and resource intensive task. For example, when RFID tags are used in a warehouse or retail setting, thousands of boxes or consumer products can be included within range of the RFID reader for inventorying. Many locations (e.g., warehouses, stores, or other environments or scenarios involving the use of RFID technology for inventorying) are large enough that RFID readers are generally unable to communicate with all RFID tags in an area. For example, RFID wireless communication technologies are generally short-range wireless technologies. Many passive RFID tags are configured to communicate with RFID readers at fifteen meters or less. In scenarios or environments, such as a store or warehouse, many RFID tags can be out of range of an RFID reader when the RFID reader is in a fixed location. RFID readers in such examples can be mobile devices allowing a user to move the position of the RFID readers to inventory additional RFID tags initially out of range of the RFID reader.

Additionally, an amount or level of transmission power of the RFID reader can be associated with a communication range of the RFID reader. For example, increasing a transmission power level of the RFID reader can increase a communication range of the RFID reader with RFID tags. By increasing a power transmission level of the RFID reader, the RFID reader can communicate with RFID tags at further distances (e.g., RFID tags which would otherwise be unreadable at lower power transmission levels).

RFID inventorying operations can be represented as a sequence of commands (or messages) from an RFID reader and replies (also referred to as responses) received from RFID tags. For example, an initial command sequence can include a Select(T)/Challenge(T) command to one or more RFID tags. In such an example, T represents transmissions from the RFID reader to the RFID tags and R represents messages or commands received by the RFID reader. For example, the Select(T)/Challenge(T) represent messages or commands transmitted from the RFID reader to the RFID tags. The Select(T) command can represent a command transmitted by the RFID reader to the RFID tags selecting a set of RFID tags with which to inventory. The Challenge(T) command (also referred to as a challenge command) can represent a command transmitted by the RFID reader to prompt the RFID tags to generate a cryptographic code or value with which the RFID reader can use to verify (e.g., authenticate) identity of the RFID tags.

The sequence of commands can further include a sequence of messages representing back and forth communication between the RFID reader and the one or more RFID tags. For example, the sequence can include a Query(T) command and a reply RN16(R) (e.g., random number 16 digit response from an RFID tag to the RFID reader). The sequence can continue with ACK(T) (e.g., an acknowledgement message or command from the RFID reader to the RFID tag confirming receipt of the RFID response which in this example is RN16(R)). The sequence can continue to with EPC (R) representing transmission of a tag identifier associated with an RFID tag. The RFID reader can store information associated with the tag identifier to indicate the RFID tag has been inventoried. In another sequence, the messages can include QueryRep(T) (e.g., a command for decrementing a slot counter of the one or more RFID tags from EPC Gen2 standards) to RN16(R) to ACK(T) to EPC(R). The aforementioned sequence can be used to read and inventory subsequent RFID tags.

In some examples, the sequence of commands can include access commands. For example, the access commands can include commands to read, write, and/or kill (e.g., deactivate) RFID tags. A read command can include a command to access data stored in memory of the RFID tag. For example, the read command can be a command to access data in registers of the RFID tags. A write command can be a command to store data in memory of the RFID tag. In such an example, the write command can be a command to store data in a register of the RFID tag.

Inventorying operations can be a power intensive process when inventorying hundreds or more RFID tags. RFID readers used in larger environments are often mobile devices because RFID readers are generally short-range wireless communication devices (e.g., with a communication range generally of 30 meters or less) and therefore unable to inventory all RFID tags in an environment without moving the RFID reader closer to the RFID tags (or vice versa).

Systems, apparatuses, electronic devices, methods (also referred to as processes), and computer-readable media (collectively referred to herein as “systems and techniques”) are described herein for wireless communication. For example, the systems and techniques are described herein for inventorying tags (e.g., RFID tags or other type of tags) using dynamic transmission power levels of an SRD (e.g., an RFID reader or other type of SRD). For example, the systems and techniques are described herein for inventorying tags using an SRD (e.g., for inventorying RFID tags using an RFID reader). In some aspects, the systems and techniques can include adjusting transmission power level of the SRD (e.g., the RFID reader) based on whether the SRD detects additional tags (e.g., additional RFID tags) to be inventoried when transmitting a transmission power level.

Examples described herein use RFID systems for illustrative purposes. However, the systems and techniques can operate using systems other than RFID systems (e.g., including one or more SRDs and one or more tags) that can communicate using other types of short range wireless communications, such as near field communication (NFC), Bluetooth™, Wi-Fi, SRD860, or other short range communication technology.

In some examples, an RFID reader can perform various inventorying operations (e.g., transmit query commands, queryrep commands, ACK commands, etc.). When the RFID reader detects no additional RFID tags to be inventoried, the RFID reader can increase a power transmission level of the RFID reader to increase a communication range of the RFID reader. For example, by adjusting the power transmission level of the RFID reader, the RFID reader can prioritize inventorying RFID tags within a closer region (e.g., a first region) to the RFID reader. When the RFID tags within the first region are inventoried (or when the RFID reader does not detect additional RFID tags within the first region to be inventoried), the RFID reader can increase a transmission power level.

Increases in the transmission power level of the RFID reader can provide wireless communication with RFID tags within a second region outside of the first region. The RFID reader can perform inventorying operations to inventory RFID tags within the second region. The RFID reader can continue to incrementally increase the transmission power level and inventory RFID tags in subsequent regions. For example, the RFID reader can perform inventorying operations and when no additional RFID tags are detected for being inventoried with a region, the RFID reader can increase the transmission power level and begin inventorying RFID tags in a subsequent region.

Byway of example, a first transmission power level (e.g., an initial transmission power level) of the RFID reader can be 18 decibels (dB). The RFID reader can increment the transmission power level by a transmission power level delta (e.g., T_Delta). In some examples, the transmission power level delta is a predetermined value. For example, the T_Delta can be 6 dB. In such an example, a first transmission power level can be 18 dB, a second transmission power level can be 24 dB, a third transmission power level can be 30 dB, etc. In other examples, the T_Delta can be variable. For example, the T_Delta can decrease, or increase based on an expected number of RFID tags in a region and a predetermined maximum transmission power level.

The predetermined maximum transmission power level can represent maximum power setting of the RFID device at which the RFID reader can transmit commands. In other examples, the predetermined transmission power level is based on physical limitations of the RFID reader. The RFID reader can decrement a slot counter associated with the number of RFID tags in a region associated with the maximum transmission power level. In such an example, the RFID reader can terminate (e.g., end) inventorying operations when the RFID does not detect additional RFID tags to be inventoried, and the slot counter is decremented to 0.

In some aspects, the RFID reader can adjust the transmission power level periodically. For example, the RFID reader can determine to perform inventorying operations for a predetermined period of time. When the predetermined period of time expires, the RFID reader can adjust transmission level to include RFID tags out of range at the previous transmission power level. In some examples, the RFID reader can periodically adjust the transmission power level to the maximum transmission power level to determine whether additional RFID tags have moved within range of the RFID reader. In such an example, the RFID reader can perform inventorying actions using a first transmission power level and automatically adjust the transmission power level to identify whether additional RFID tags have been introduced to other regions (e.g., regions outside of the first transmission power level).

In some aspects, the systems and techniques can include adjusting the transmission power level of the RFID reader based on movement of the RFID reader. For example, the RFID reader can be used in environment larger than the maximum transmission power level of the RFID reader. In such an example, a user can move the RFID reader throughout the environment to inventory RFID tags initially outside of the range of the RFID reader. In some aspects, the RFID reader can adjust the transmission power level based on a determination the RFID reader has been moved a distance greater than a predetermined distance threshold.

In some aspects, the RFID reader can include or can be part of an electronic device including various components to detect and track RFID reader location and movement. For example, the RFID reader can include a velocity sensor. The RFID reader can determine movement of the RFID reader from an initial location using the velocity sensor. For example, the RFID reader can determine an updated RFID reader location based on speed, time of travel (e.g., how long the RFID was in motion), and direction of the RFID reader movement. In such an example, when the distance of between updated RFID reader location and the initial location exceeds a predetermined distance threshold, the RFID reader can adjust the transmission power level, such as by adjusting the transmission power level to a first power level.

In another example, the RFID reader can include a speed sensor. The RFID reader can use the speed sensor (or a velocity sensor) to determine a distance traveled by the RFID reader. In such an example, the RFID reader can adjust the transmission power level based on a distance traveled by the RFID reader. The RFID reader can determine a distance traveled by the RFID reader based on an amount of time traveled and the speed of the RFID reader during travel. The RFID reader can adjust the transmission power level to the first power level when the distance traveled exceeds the predetermined distance threshold.

In a further example, the RFID reader can include a Global Navigation Satellite System (GNSS), such as a Global Positioning System (GPS), to determine an absolute location (e.g., location represented in global coordinates) of the RFID reader. For example, the RFID reader can receive information associated with the location of the RFID reader from the GPS. The RFID reader can compare the absolute location with a previous location of the RFID reader to determine a distance traveled by the RFID reader. When the distance traveled exceeds the predetermined distance threshold, the RFID reader can adjust the transmission power level of the RFID reader.

In some aspects, the RFID reader can perform additional inventorying actions when tracking location of the RFID reader. For example, the RFID reader can perform location check operations to track the location of the RFID reader at each RFID tag inventorying action. For example, the RFID reader can store location data associated with the location of the RFID reader when the RFID reader inventoried an RFID tag. For example, the RFID reader or the RFID tag can include a memory location such as a flag associated with the location of the RFID reader. The RFID reader or RFID tag can update the flag based on the RFID location. In further examples, the RFID reader can compare the location of the RFID reader to a previous RFID reader location based on the flag or stored location data. When the location is changed, the RFID reader can compare whether the updated location is within a predetermined distance threshold of the previous RFID location and set a location changed flag of the RFID tag or RFID reader. When the updated location is greater than the predetermined distance threshold, the RFID reader can adjust the transmission power level (e.g., such as by adjusting the transmission power level to a lower transmission power level).

Various aspects of the present disclosure will be described with respect to the figures.

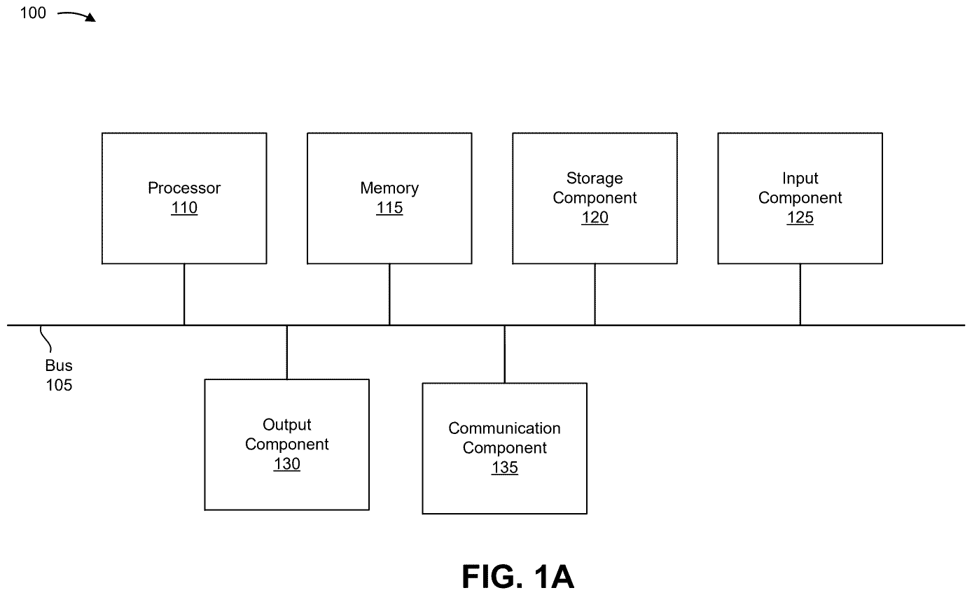

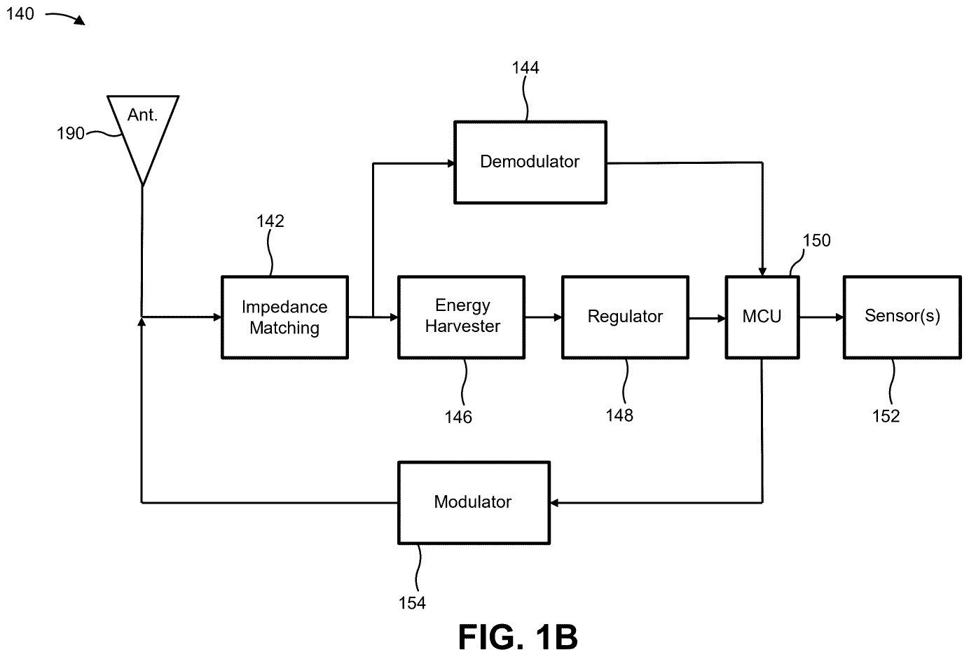

FIG. 1A is a diagram illustrating example components of a device 100, in accordance with the present disclosure. As shown in FIG. 1A, device 100 may include a bus 105, a processor 110, a memory 115, a storage component 120, an input component 125, an output component 130, and/or a communication component 135.

Bus 105 may include a component that permits communication among the components of device 100. Processor 110 may be implemented in hardware, firmware, or a combination of hardware and software. Processor 110 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 110 may include one or more processors capable of being programmed to perform a function. Memory 115 may include a random access memory (RAM), a read only memory (ROM), and/or another type of dynamic or static storage device (e.g., a flash memory, a magnetic memory, and/or an optical memory) that stores information and/or instructions for use by processor 110.

Storage component 120 can store information and/or software related to the operation and use of device 100. For example, storage component 120 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 125 may include a component that permits device 100 to receive information, such as via user input (e.g., a touch screen display, a keyboard, a keypad, a mouse, a button, a switch, and/or a microphone). Additionally, or alternatively, input component 125 may include a component for determining a position or a location of device 100 (e.g., a global positioning system (GPS) component or a global navigation satellite system (GNSS) component) and/or a sensor for sensing information (e.g., an accelerometer, a gyroscope, an actuator, or another type of position or environment sensor). Output component 130 can include a component that provides output information from device 100 (e.g., a display, a speaker, a haptic feedback component, and/or an audio or visual indicator).

Communication component 135 may include one or more transceiver-like components (e.g., a transceiver and/or a separate receiver and transmitter) that enables device 100 to communicate with other devices, such as via a wired connection, a wireless connection, or a combination of wired and wireless connections. Communication component 135 may permit device 100 to receive information from another device and/or provide information to another device. For example, communication component 135 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 135 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some cases, the antenna may be configured to emit continuous wave communications that can stimulate energy in an energy harvesting device (e.g., a RFID tag) such as energy harvesting device 140 shown in FIG. 1A. In some cases, the antenna may be configured to receive RFID communications from such an energy harvesting device.

The one or more transceiver-like components (e.g., a wireless transceiver) of the communication component 135 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 110) to encode and/or decode data transmitted and/or received using the one or more wireless transceivers. In some cases, encryption-decryption may be implemented (e.g., by the processor 110) to encrypt and/or decrypt data (e.g., according to the Advanced Encryption Standard (AES) and/or Data Encryption Standard (DES) standard) transmitted and/or received by the one or more wireless transceivers.

In some aspects, device 100 may represent an ESL. The ESL may include a battery in addition to the aforementioned components. In some aspects, the output component 130 of the ESL may be an electronic paper (e-paper) display or a liquid crystal display (LCD).

Device 100 may perform one or more processes described herein. Device 100 may perform these processes based on processor 110 executing software instructions stored by a non-transitory computer-readable medium, such as memory 115 and/or storage component 120. A computer-readable medium is defined herein as a non-transitory memory device. A memory device includes memory space within a single physical storage device or memory space spread across multiple physical storage devices.

Software instructions may be read into memory 115 and/or storage component 120 from another computer-readable medium or from another device via communication component 135. When executed, software instructions stored in memory 115 and/or storage component 120 may cause processor 110 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 1A are provided as an example. In practice, device 100 may include additional components, fewer components, different components, or differently arranged components than those shown in FIG. 1A. Additionally, or alternatively, a set of components (e.g., one or more components) of device 100 may perform one or more functions described as being performed by another set of components of device 100.

FIG. 1B is a diagram illustrating an example of an architecture of a radio frequency (RF) energy harvesting device 140, in accordance with some examples. As will be described in greater depth below, the RF energy harvesting device 140 can harvest RF energy from one or more RF signals received using one or more antennas 190. As used herein, the term “energy harvesting” may be used interchangeably with “power harvesting.” In some aspects, energy harvesting device 140 can be implemented as an Internet-of-Things (IoT) device, can be implemented as a sensor, etc., as will be described in greater depth below. In other examples, energy harvesting device 140 can be implemented as a Radio-Frequency Identification (RFID) tag or various other RFID devices.

The energy harvesting device 140 includes the one or more antennas 190 that can be used to transmit and receive one or more wireless signals. For example, energy harvesting device 140 can use antenna(s) 190 to receive one or more downlink signals and to transmit one or more uplink signals. An impedance matching component 142 can be used to match the impedance of antenna(s) 190 to the impedance of one or more (or all) of the receive components included in energy harvesting device 140. In some examples, the receive components of energy harvesting device 140 can include a demodulator 144 (e.g., for demodulating a received downlink signal), an energy harvester 146 (e.g., for harvesting RF energy from the received downlink signal), a regulator 148, a micro-controller unit (MCU) 150, a modulator 154 (e.g., for generating an uplink signal). In some cases, the receive components of energy harvesting device 140 may further include one or more sensors 152.

The downlink signals can be received from one or more transmitters. For example, energy harvesting device 140 may receive a downlink signal from a network node or network entity that is included in a same wireless network as the energy harvesting device 140. In some cases, the network entity can be a base station, gNB, etc., that communicates with the energy harvesting device 140 using a cellular communication network. For example, the cellular communication network can be implemented according to the 3G, 4G, 5G, 6G, and/or other cellular standard (e.g., including future standards such as 6G and beyond).

In some cases, energy harvesting device 140 can be implemented as a passive or semi-passive energy harvesting device (e.g., an ambient energy harvesting device), which can perform passive uplink communication by modulating and reflecting a downlink signal received via antenna(s) 190. For example, passive and semi-passive energy harvesting devices may be unable to generate and transmit an uplink signal without first receiving a downlink signal that can be modulated and reflected. In other examples, energy harvesting device 140 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

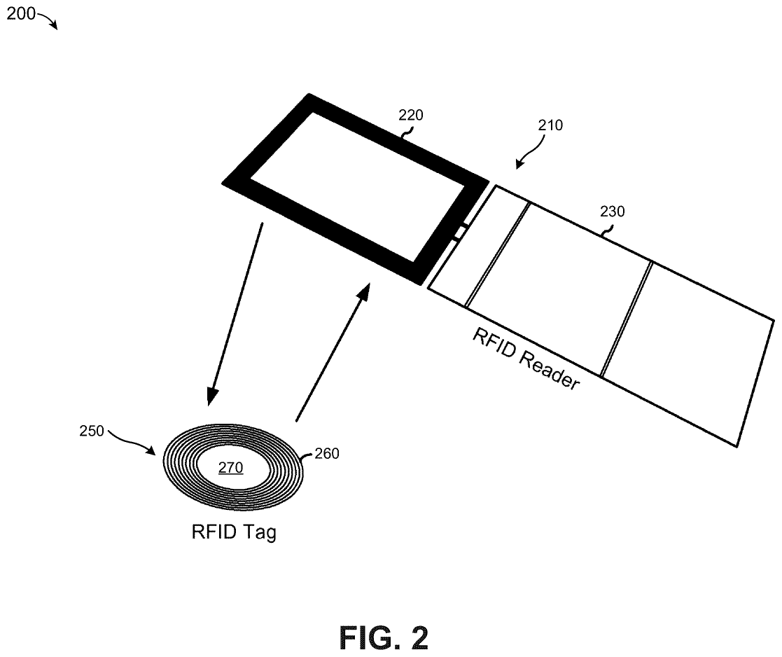

FIG. 2 is a diagram illustrating an example RFID system 200 that includes an RFID reader (e.g., energizer) 210 and an RFID tag 250. RFID reader 210 may also be referred to as an interrogator, a scanner, an energizer, etc. RFID tag 250 may also be referred to as an RFID label, an electronics label, etc.

RFID reader 210 includes an antenna 220 and an electronics unit 230. Antenna 220 radiates signals transmitted by RFID reader 210 and receives signals from RFID tags (e.g., such as the RFID tag 250) and/or other devices. Electronics unit 230 may include a transmitter and a receiver for reading RFID tags such as RFID tag 250. The same pair of transmitter and receiver (or another pair of transmitter and receiver) may support bi-directional communication with wireless networks, wireless devices, etc. In some examples, a first RFID reader or RFID device can include a transmitter for energizing one or more RFID tags, and a second RFID reader or RFID device can include a receiver for receiving the reflected signals from the one or more RFID tags. For instance, an RFID reader can be configured to implement energizing and tag reading capabilities (e.g., includes a transmitter and a receiver), can be configured to implement energizing capabilities (e.g., includes a transmitter), and/or can be configured to implement tag reading capabilities (e.g., includes a receiver). The electronics unit 230 may include processing circuitry (e.g., a processor) to perform processing for data being transmitted and received by RFID reader 210.

RFID tag 250 includes an antenna 260 and a data storage element 270. Antenna 260 radiates signals transmitted by RFID tag 250 and receives signals from RFID reader 210 and/or other devices. For instance, RFID tags can be passive, active, or semi-active. Passive RFID tags utilize the interrogating signal from an RFID reader to power a transmission by or from the RFID tag. Active and semi-active RFID tags can include a power source or battery, which can be used to power a transmission by or from the RFID tag. In some examples, the RFID tag 250 may be a passive RFID tag having no battery. In this case, a magnetic field from a signal transmitted by RFID reader 210 (e.g., an energizing or interrogating signal from the RFID reader 210) may induce an electrical current in RFID tag 250, which may then operate based on the induced current. RFID tag 250 can radiate its signal in response to receiving a signal from RFID reader 210 or some other device.

The RFID tag 250 can use the data storage element 270 to store identification information corresponding to the RFID tag 250 and/or corresponding to an item associated with the RFID tag 250 (e.g., an item to which the RFID tag 250 is attached, etc.). For example, data storage element 270 can be used to store identification information using various granularity levels for tracking and management of an RFID tagged item. An RFID tag attached to a respective item, or attached to a group of items, may store corresponding information thereof. For example, the RFID tag 250 can be configured to store, using data storage element 270, identification information corresponding to the item(s) to which the RFID tag 250 is attached and associated. For instance, RFID tag information can include one or more of a product name, a serial number, product information, a manufacturer, etc. In some examples, the RFID tag 250 can store (e.g., using the data storage element 270) identification information that is directly indicative of a tagged item, product, object, etc. For instance, the RFID tag 250 can store identification information such as a unique product serial number, etc. In some examples, the RFID tag 250 does not store product or item identification information directly, and stores a unique RFID tag serial number or identification number corresponding to the RFID tag 250, which may be externally mapped to various item identification information such as product serial numbers, product names, product SKUs, etc.

Data storage element 270 can be configured to store identification information for RFID tag 250, e.g., in an electrically erasable programmable read-only memory (EEPROM). RFID tag 250 may also include an electronics unit that can process the received signal and generate the signals to be transmitted.

RFID tag 250 may be read as follows. RFID reader 210 may be placed or moved within close proximity to RFID tag 250. RFID reader 210 may radiate a first signal (which is also called an interrogation signal) via antenna 220. The energy of the first signal may be coupled from RFID reader antenna 220 to RFID tag antenna 260 via magnetic coupling and/or other phenomena. RFID tag 250 may receive the first signal from RFID reader 210 via antenna 260 and, in response, may radiate a second signal (which is also referred to as a responding signal) comprising the information stored in data storage element 270. RFID reader 210 may receive the second signal from RFID tag 250 via antenna 220 and may process the received signal to obtain the information sent in the second signal.

RFID system 200 may be designed to operate at various frequencies and/or frequency ranges. For example, RFID system 200 can operate at 900 MHz, within a range of 860-960 MHz, etc., among various other example frequencies and/or frequency ranges of RFID operations. RFID reader 210 may have a specified maximum transmit power level, which may be imposed by the Federal Communication Commission (FCC) in the United Stated or other regulatory bodies in other countries.

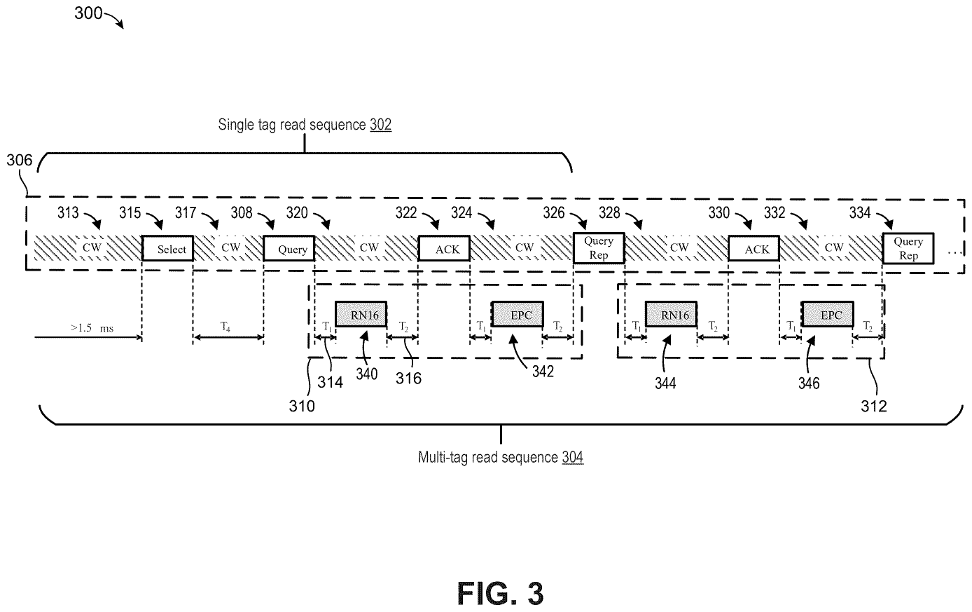

FIG. 3 is a block diagram 300 illustrating an example inventorying process over a period of time for a single tag sequence 302 and a multi-tag sequence 304. The block diagram 300 illustrates an example of illustrates a reader device (e.g., an RFID reader 306) in communication with a plurality of RFID tags (e.g., a first RFID tag 310 and a second RFID tag 312). As shown, one or more RFID tags (e.g., RFID tag 310, RFID tag 312, etc.) may be read in sequence. The block diagram 300 includes an example of a single tag sequence 302 and an example of a multi-tag sequence 304. As depicted, the single tag sequence 302 and the multi-tag sequence 304 both include a sequence of various transmissions and receptions. Sequences 302 and 304 are exemplary and, as such, multiple different variations are possible. The sequence 302 and the sequence 304 each include various continuous wave segments, during which a continuous wave is emitted via an antenna on a device (e.g., a reader device). The sequence 302 and the sequence 304 each also include various receive segments, during which the device (e.g., the RFID reader 306) can listen for transmissions from the one or more RFID tags. The CW energizes any tags located within communications range of the device (e.g., the reader device), or if the tags are already energized, maintains the tags energized before the tags are read.

The single tag sequence includes continuous wave (CW) 313, select 315, CW 317, query 308, CW 320 (and RN16 message 344), Acknowledgement (ACK) 322, and CW 324 (and EPC message 342). In the single tag sequence, a reader device can use the sequence Query(T)->RN16(R)->ACK(T)->EPC(R) to read one tag, where “T” refers to the reader device transmitting and “R” refers to the reader device receiving (e.g., where the tag is transmitting). For instance, the reader device can first transmit a continuous wave (CW) 313. In the example depicted, the transmission time may be 1.5 milliseconds (ms), but other durations are also possible.

Continuing the example, the reader device can then transmit a Select(T)/Challenge(T) message 315 to one or more of the tags. The reader device can then transmit a second CW 317 (which may be the same CW as the CW 313) for a time T₄. In response, a tag can emit the RN16 message 340, T₁ time after a start of the transmission of the CW 320 and ending at T₂ time prior to the end of the transmission of the CW 320. During this time, the reader device can continue to emit the CW 320. The reader device can respond with an ACK message 322. In response, the tag can emit an EPC message 342, while the reader device continues to emit the CW 324. The EPC message 342 can be emitted T1 time after the start of the transmission of the CW 324 and ending T₂ time prior to the end of the transmission of the CW 324.

The Electronic Product Code (EPC) Radio-Frequency Identity Generation-2 Ultra High Frequency (UHF) RFID standard (e.g., an RFID specification) provides for a potentially short turnaround time for timers T₁ and T₂. This short turnaround time requires a need for substantial computational resources, in addition to at least one antenna for an RFID application. In some cases, meeting additional requirements may be required. Such requirements may include frequency-hopping spread spectrum (FHSS) signaling for UL signals in the United States (US), and a need to meet anti-jammer requirements in the European Union (EU).

The multi-tag sequence 304 includes the operations of single tag sequence, followed by one or more repetitions of parts of the single tag sequence 302, such as Query repeat (Rep) 326, CW 328, ACK 330, CW 332, Query Rep 334, RN16 message 344, and EPC message 346. More specifically, multi-tag sequence 304 includes messages QueryRep(T)->RN16(R)->ACK(T)->EPC(R) to read subsequent tags, which follows the initial message sequence, with a particular pre-defined timing cadence. These messages may be repeated, once for each additional tag.

A duration of the sequences depends upon a particular configuration that the reader device selects for transmitting and receiving data transmissions. In an example, a typical duration of the single tag sequence is from 1.2 to 50 ms. By contrast, the multi-tag sequence 304 may range as follows:

$$\{ 1.2 - 50 \} + ( a no\_of \_tags read ) * \{ 0.5 - 41 \} ms$$

In some cases, at least 1.5 ms may be needed to power up tags before sending any commands.

In one or more aspects, GS1 EPC Class1 Gen2 specifies a procedure for a reader device to extract EPCs from signals from multiple passive RFID devices (e.g., RFID tags). A slot counter is employed for this procedure. In one example, the RFID reader 306 can generate a command such as query 308 to request a response from the first RFID tag 310. In such an example, the RFID reader 306 can transmit the query 308 to the plurality of RFID tags. The first RFID tag 310 can respond to the RFID reader 306 with an immediate RF reply (e.g., a responsive RF wave) within the time period (e.g., or before a first time threshold 314, also referred to as T1).

The first RFID tag 310 can respond to the RFID reader 306 within the first time threshold 314. For example, the first RFID tag 310 can respond with an RN16 message or another responsive RF signal. The RFID reader 306 can generate and transmit an acknowledgement (ACK) message in response to the message from the first RFID tag 310 (e.g., by repeating the RN16 back to the first RFID tag 310). The RFID reader 306 can respond within a second time threshold 316 (e.g., T2, also referred to as a second time period). T2 can represent a time threshold before which the RFID tag should transmit a response to the first RFID tag 310. In some examples, failure to transmit a response to the first RFID tag 310 before expiration of T2 can result in the first RFID tag 310 entering an arbitrate state (e.g., an arbitration state) of the inventorying process. In the multi-tag sequence 304, the RFID reader can transmit a QueryRep command and continue the inventorying process with the second RFID tag 312.

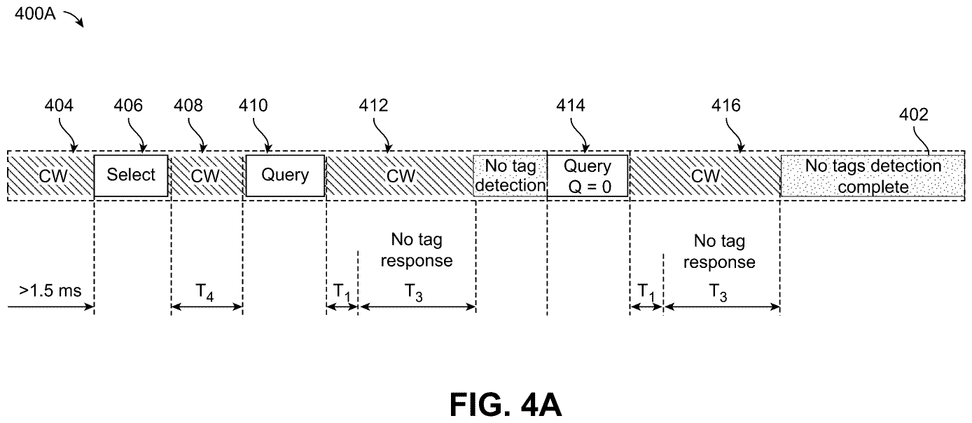

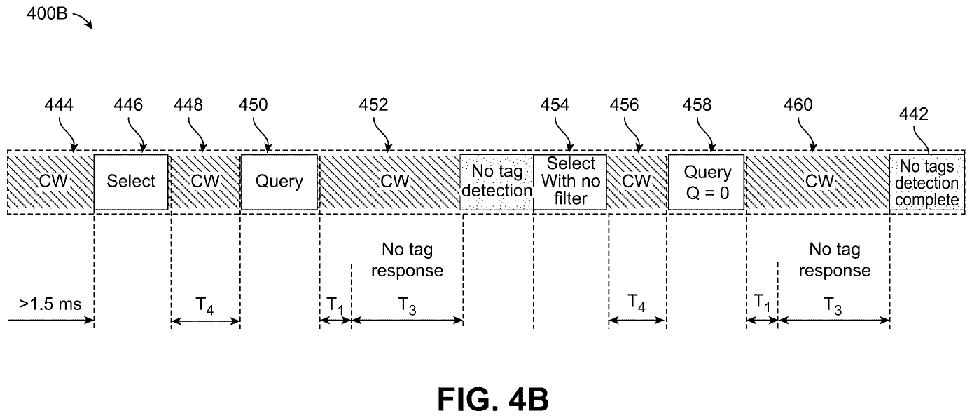

FIG. 4A is a block diagram 400A illustrating an example inventorying process using dynamic power transmission of an RFID reader 402. The RFID reader can output a CW 404 and a select command 406. The select command 406 can include information associated with a set of RFID tags to respond during inventorying. For example, the select command 406 can include a filter associated with a set of RFID tags to perform inventorying operations. In such an example, the select command can include criteria or information associated with tags to be inventoried (e.g., inventorying RFID tags based on the type of RFID tag, location of the RFID tag, or characteristics of the RFID tag such as manufacturer information, etc.). When the RFID tags are within the set of RFID tags associated with the criteria of the select command 406, the RFID tags can respond to queries associated with a corresponding RFID tag.

FIG. 4A illustrates an example inventorying process with no additional RFID tags to be inventoried at a transmission power level (e.g., no additional RFID tags to be inventoried within a range of distances associated with the transmission power level). The RFID reader 402 can wait a time period (e.g., T4 associated with a minimum wait time between transmission of interrogatory commands) during CW 408 before sending a Query 410. The RFID reader 402 can wait for an RFID tag to respond for a predetermined period of time (e.g., T1 and T2 during CW 412). When no tag responds, the RFID reader can decrement a slot counter of the RFID reader and output Query 414 including an indicator that the slot counter (e.g., Q) is set to 0. When the RFID reader 402 does not receive a response from RFID tags after waiting T1 and T2 during CW 416, the RFID can determine to increase the transmission power level of the RFID reader 402.

FIG. 4B is a block diagram 400B illustrating an example inventorying process using dynamic power transmission of an RFID reader 442 to adjust a transmission power level of the RFID reader 402 to a predetermined maximum transmission power level.

The RFID reader can output a CW 444 and a select command 446. The select command 446 can include information associated with a set of RFID tags to respond during inventorying. The RFID reader 442 can wait for a response from an RFID tag. After a predetermined period of time elapses during CW 448, the RFID reader 442 can transmit a Query 450. The RFID reader 442 can wait for an RFID tag response to the Query 450 during CW 452. When no RFID tag response is detected, the RFID reader 442 can increase the transmission power level to the predetermined maximum transmission power level.

The RFID reader 442 can output a select command 454. The select command 454 can be a select command to request response from any remaining RFID tags that have not been inventoried when operating at the predetermined maximum transmission power level. The RFID reader 442 can wait during CW 456 (e.g., T4 representing a minimum period of time for an RFID reader to transmit interrogatory commands). After T4 expires, the RFID reader 442 can transmit Query 458. Query 458 can include a slot counter set to 0 to prompt any remaining RFID tags to be inventoried to respond during CW 460. For example, the RFID reader 442 can output the query 458 to all RFID tags within range of the RFID reader outputting at the predetermined maximum transmission threshold requesting response. In some examples, when a response is received from an RFID tag, the RFID reader 442 can inventory the RFID tag. The RFID tags still remaining to be inventoried can respond to the query 458.

FIG. 4B illustrates a scenario with no additional RFID tags to be inventoried. No additional RFID tags respond during CW 460. The RFID reader 442 can determine all RFID tags within range of the RFID reader have been inventoried based on a lack of response by the RFID tags. The RFID reader can terminate inventorying operations when the RFID reader determines all available RFID tags have been inventoried.

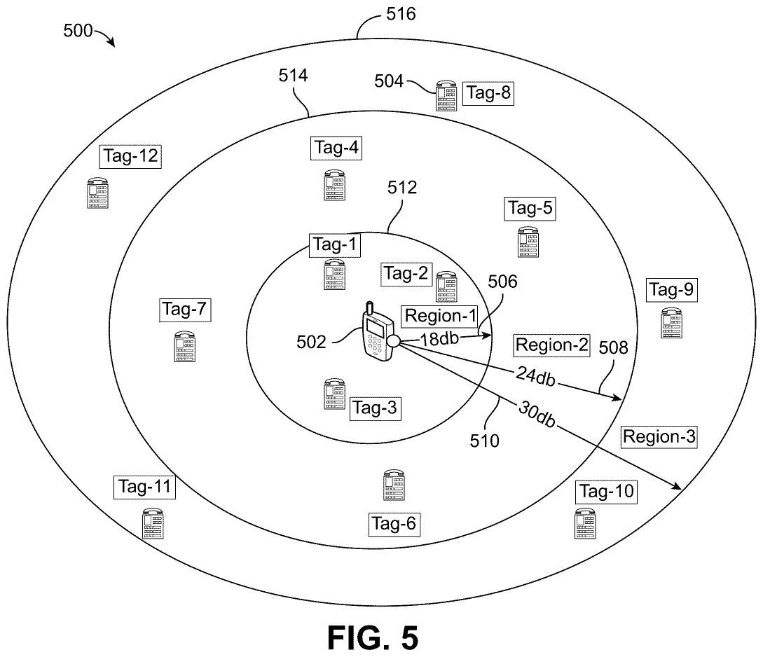

FIG. 5 is a block diagram 500 illustrating an RFID reader 502 in an environment with a plurality of RFID tags 504. The RFID reader 502 can output commands (e.g., inventorying commands, access commands, and/or other types of commands) at various transmission power levels. For example, the RFID reader 502 can output the commands at a first transmission power level 506, a second transmission power level 508, and a third transmission power level 510.

Each transmission power level is associated with a corresponding region. For example, the first transmission power level 506 can be associated with a first region 512, the second transmission power level 508 can be associated with a second region 514, and the third transmission power level 510 can be associated with a third region 516. For example, the RFID reader 502 can initially output commands at an 18 dB transmission power level to inventory RFID tags within the first region 512. The RFID reader 502 can adjust the transmission power level when the RFID tags within the first region 512 are all inventoried. For example, the RFID reader 502 can adjust the first transmission power level 506 to the second transmission power level 508 (e.g., 18 dB to 24 dB) to inventory RFID tags within the second region 514.

The third transmission power level 510 can represent a predetermined maximum transmission power level. For example, when the RFID reader 502 determines all RFID tags 504 have been inventoried in the second region 514, the RFID reader 502 can output commands at the third transmission power level 510 to RFID tags 504 in the third region 516, or any additional RFID tags 504 remaining to be inventoried within range of the RFID reader 502.

The RFID reader 502 can increment the transmission power level by a transmission power level delta (e.g., T_Delta). The transmission power level delta can be a preset value representing the increase in power when incrementing transmission power levels. For example, the second transmission power level 508 can represent a jump of one delta, in the current example of 6 dB. In other examples, the T_Delta can be variable. For example, the T_Delta can decrease, or increase based on an expected number of RFID tags in a region and based on a predetermined maximum transmission power level.

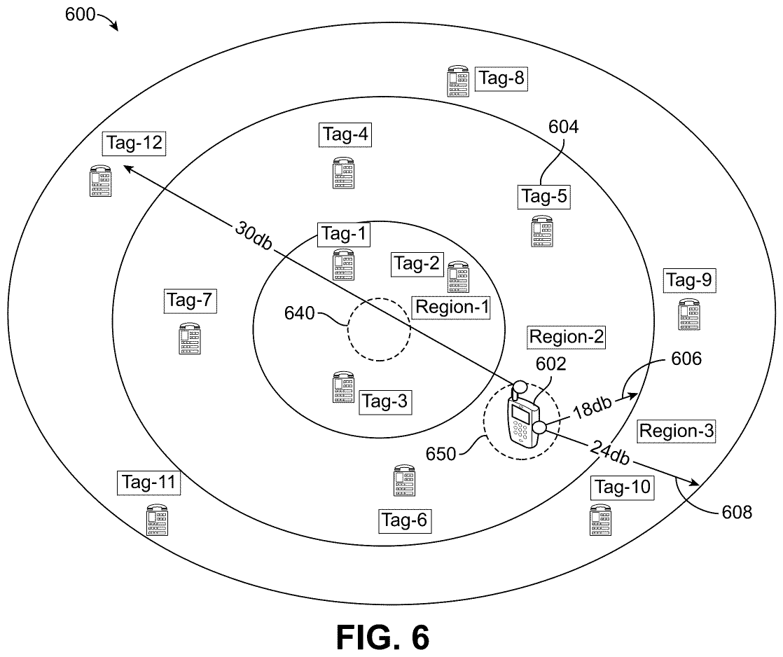

FIG. 6 is a block diagram illustrating inventorying operations when an RFID reader 602 has moved locations. For example, RFID reader 602 can begin RFID inventorying of RFID tags 604 at location 640. The RFID reader 602 can be moved from location 640 to location 650. When the change in position of the RFID reader 602 (e.g., from the location 640 to the location 650) is greater than a predetermined distance threshold, the RFID reader 602 can adjust a transmission power level of the RFID reader 602. For example, the RFID reader 602 can adjust a location flag of the RFID reader 602 or RFID tags 604 indicating the RFID reader 602 moved to a new location and the transmission power level was adjusted. In such an example, the RFID reader 602 can adjust a transmission power level of the RFID reader 602 to a first transmission power level 606 (e.g., an 18 dB transmission power level).

When the RFID reader 602 has inventoried all of the RFID tags (or all of the RFID tags detected by the RFID reader 602) within range of the RFID reader operating using the first transmission power level 606, the RFID reader 602 can adjust the transmission power level to a second transmission power level 608. The second transmission power level 608 can be a higher transmission power level than the first transmission power level 606 (e.g., 24 dB vs. 18 dB). The RFID reader 602 can perform inventorying operations of RFID tags within range of the RFID reader 602 transmitting at the second transmission power level 608.

The RFID reader 602 can adjust power transmission levels based on movement of the RFID reader. For example, the RFID reader 602 can be used in an environment larger than a wireless communication range of the RFID reader when transmitting at maximum transmission power level (e.g., generally an environment with distances greater than 30 meters). In such an example, users can move the RFID reader 602 throughout the environment to inventory RFID tags 604 initially out of range of the RFID reader 602. The RFID reader can adjust the transmission power level based on a determination the RFID reader has been moved a distance greater than a predetermined distance threshold. For example, the RFID reader 602 can monitor movement of the RFID reader 602 using a velocity sensor. In such an example, the velocity sensor can indicate a speed and direction of the RFID reader 602 in motion.

In such an example, the RFID reader 602 can use the speed, time of travel, and direction of the RFID reader 602 as measured by the velocity sensor to determine whether the RFID reader 602 moved a distance greater than a predetermined distance threshold. When the distance is greater than the threshold, the RFID reader 602 can adjust the power transmission level. Adjustments to the power transmission level can include reducing the power transmission level to an initial power transmission level (e.g., adjusting from the second transmission power level 608 to the first transmission power level 606, etc.).

In some examples, the RFID reader 602 can include a speed sensor. The RFID reader 602 can determine a distance traveled based on the speed of the RFID reader 602 and the time traveled. When the distance traveled by the RFID reader 602 exceeds the predetermined distance threshold, the RFID reader 602 can adjust the transmission power level. In a further example, the RFID reader 602 can include a GPS (or other GNSS). The RFID reader 602 can receive coordinates associated with an absolute location of the RFID reader 602. The RFID reader 602 can compare coordinates of the RFID reader 602 with the coordinates of a prior position of the RFID reader 602. When the distance exceeds a predetermined distance threshold, the RFID reader 602 can adjust the transmission power level.

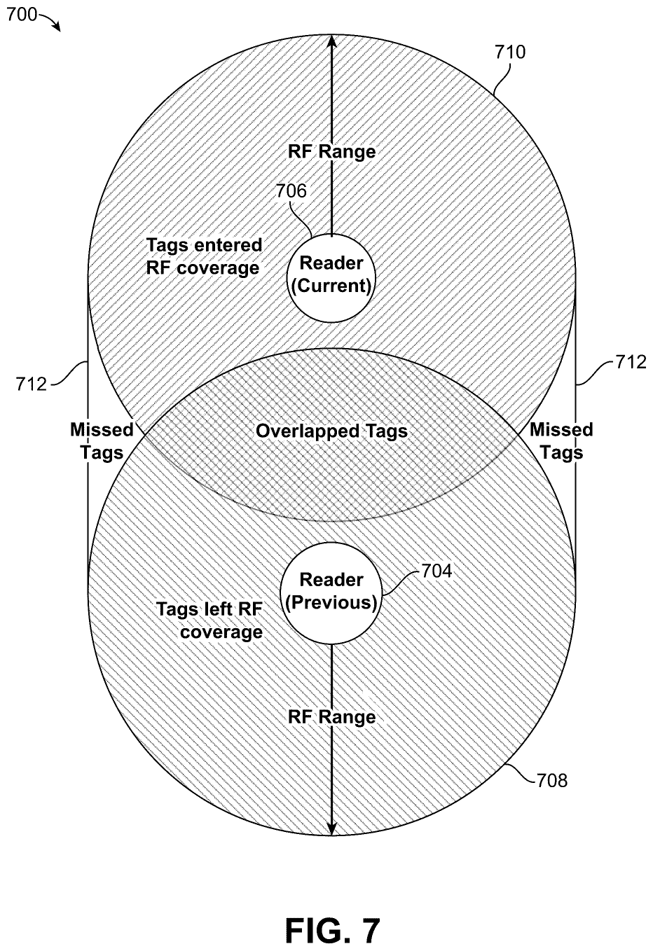

FIG. 7 is a block diagram 700 illustrating an example of wireless communication range of a mobile RFID reader. The block diagram 700 illustrates movement of the RFID reader from a first position 704 to a second position 706. By way of example, the RFID reader of FIG. 7 is illustrated as having an equal range in all directions from the RFID reader, as shown by a first wireless communication range 708 associated with the range of the RFID reader at the first position 704 and a second wireless communication range 710 associated with the range of the RFID reader at the second position 706.

In some environments, such as environments with obstructions such as walls or objects, the range of the RFID reader can be different based on the location of the obstructions. FIG. 7 illustrates an overlap in the range of the RFID reader at the first position 704 and the second position 706. FIG. 7 further illustrates a gap in the range of the RFID reader at missed tags area 712 (e.g., an area with RFID tags which were not detected by the RFID reader due to being out of range of the RFID reader).

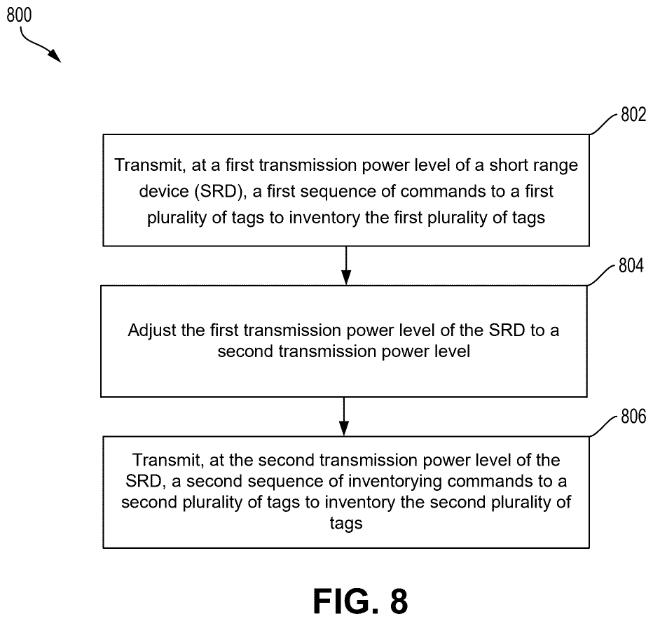

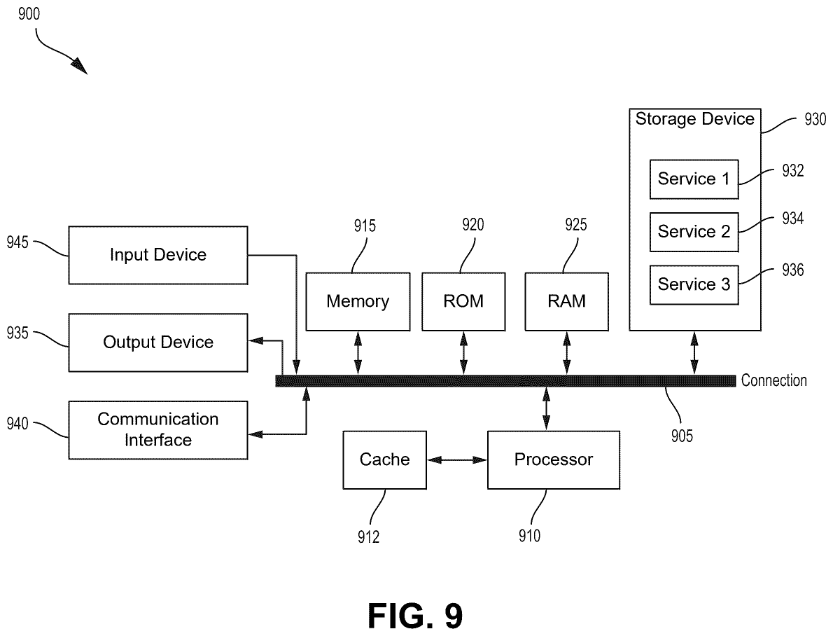

FIG. 8 is a flow diagram illustrating an example process 800 for wireless communication. In particular, the process 800 illustrates an example process of inventorying tags (e.g., RFID tags), such as the RFID tag 250 of FIG. 2 or the RFID tag described in communication with the RFID reader 402 in the description of FIG. 4A. The process 800 can be performed by a computing device (e.g., the device 100 of FIG. 1A, an SRD such as the RFID reader 402 of FIG. 4A and/or the RFID reader 502 of FIG. 5, the computing device or computing system 900 of FIG. 9, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 800 can be implemented as software components that are executed and run on one or more processors (e.g., processor 110 of FIG. 1A, the processor 910 of FIG. 9, or other processor(s)) of the computing device. Further, the transmission and reception of signals by the computing device in the process 800 can be enabled, for example, by one or more antennas and/or one or more transceivers (e.g., wireless transceiver(s)).

At block 802, the computing device (or component thereof) can transmit, at a first transmission power level of a short range device (SRD) (e.g., a radio frequency identification (RFID) reader or other type of SRD), a first sequence of commands to a first plurality of tags (e.g., RFID tags or other types of tags) to inventory the first plurality of tags. In some examples, the first sequence of commands and the second sequence of commands can include inventorying commands to inventory the first plurality of tags and the second plurality of tags. In further examples, the first sequence of commands and the second sequence of commands can include a query, and an acknowledgement command (ACK) generated in response to reception of a reply by a tag (e.g., an RFID tag). For example, the commands can include a query command and/or an ACK command further described in the description of FIG. 3. In further examples, the reply by the tag can be a 16 digit random number (e.g., RN16) reply. For example, the RN16 reply can be the RN16 described in the description of FIG. 3. In another example, the first sequence of commands and the second sequence of commands can include a select command to select a plurality of tags (e.g., a plurality of RFID tags) to inventory. For example, the select command can be a select command described in the description of FIG. 3. In another example, the first sequence of commands and the second sequence of commands can include access commands to read, write, and kill the first plurality of tags and the second sequence of commands includes access commands to read, write, and kill the second plurality of tags. For example, kill commands can be a command to deactivate a tag (e.g., an RFID tag). A read command can be a command to access data stored in memory of the tag. A write command can be a command to store data in memory of the tag.

At block 804, the computing device (or component thereof) can adjust the first transmission power level of the SRD to a second transmission power level. For example, the first transmission power level of the SRD can be associated with a range of the SRD. In such an example, the SRD range of communication with tags (e.g., an RFID reader range of communication with RFID tags) can be based on the transmission power level of the SRD. In some examples, the SRD can have discrete transmission power levels (e.g., transmission power level 1, transmission power level 2, etc.). In further examples, the transmission power levels can be a spectrum of transmission power levels. In some examples, the second transmission power level is greater than the first transmission power level. In such an example, the SRD can transmit commands at a greater range when transmitting commands using the second transmission level. In further examples, the computing device (or component thereof) can adjust a first transmission power level to the second transmission power level periodically. For example, the computing device can adjust the first transmission power level every set period of time (e.g., adjust the first transmission power level every 30 seconds, etc.).

At block 806, the computing device (or component thereof) can transmit, at the second transmission power level of the SRD, a second sequence of commands to a second plurality of tags (e.g., a second plurality of RFID tags) to inventory the second plurality of tags. In some examples, the computing device (or component thereof) can adjust the first transmission power level to the second transmission power level based on completion of inventorying each tag of the first plurality of tags. For example, the second transmission power level can be a higher transmission level than the first transmission level. In such an example, the second transmission power level can allow the SRD to transmit commands to tags (e.g., RFID tags) at greater distances than when using the first transmission power level.

In some examples, the computing device (or component thereof) can adjust the second transmission power level of the SRD to a third transmission power level. In such an example, the third transmission power level can be associated with a predetermined maximum transmission power level of the SRD. For example, the predetermined maximum transmission power level can represent maximum power setting of the device at which the SRD can transmit commands. In other examples, the predetermined transmission power level can be based on physical limitations of the SRD.

In some aspects, the computing (or component thereof) can transmit, at the third transmission power level of the SRD, a third sequence of commands to a third plurality of tags to inventory the third plurality of tags. In some examples, the third sequence of commands can include inventorying commands such as select, query, query rep, ACK, and other commands. Additionally or alternatively, in some examples, the third sequence of commands can include a query with a slot counter value set to prompt reply by tags (e.g., RFID tags) remaining to be inventoried. In some examples, the computing device (or component thereof) can determine to terminate inventorying operations of the SRD based on the SRD not detecting additional tags (e.g., additional RFID tags) to be inventoried. In such an example, the SRD can determine no additional tags based on the SRD not detecting further tags when the SRD is transmitting commands at a predetermined maximum transmission power level.

In another example, the computing device (or component thereof) can determine a change in position of the SRD. In further examples, the computing device (or component thereof) can adjust the second transmission power level of the SRD to the first transmission power level. In such an example, the adjustment can be based on the change in the position of the SRD exceeding a predetermined threshold. For example, the SRD can be mobile. When the SRD is moved a distance exceeding the predetermined threshold (e.g., a predetermined distance threshold), the computing device (or component thereof) can adjust the transmission power level. In some examples, the computing device (or component thereof) can determine the change in the position exceeds the predetermined threshold based on a distance traveled by the SRD. In another example, the computing device (or component thereof) can determine the change in the position exceeds the predetermined threshold based on a speed and direction of the SRD from a velocity sensor. For example, the computing device can determine, based on the speed and direction, a distance traveled by the SRD. In a further example, the computing device (or component thereof) can determine the change in the position exceeds the predetermined threshold based on an absolute position of the SRD from a global positioning system.

In a further example, the first transmission power level can be associated with a predetermined maximum transmission power level of the SRD. In such an example, the first sequence of commands can include a select inventorying command and a query inventorying command. In a further example, the computing device (or component thereof) can transmit the first sequence of commands periodically to detect additional tags to be inventoried. In another example, the computing device (or component thereof) can determine to terminate inventorying operations of the SRD based on the SRD not detecting additional tags to be inventoried. In a further example, the computing device (or component thereof) can determine, based on a change in position of the SRD, to transmit a third sequence of commands to inventory a third plurality of tags (e.g., a third plurality of RFID tags). In such an example, the SRD can transmit commands (e.g., inventorying commands, access commands, and/or other types of commands) when the SRD is moved to determine whether additional un-inventoried tags are within range of the moved SRD.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, an engine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for wireless communications, the apparatus comprising: at least one memory; and at least one processor coupled to the at least one memory and configured to: transmit, at a first transmission power level of a short range device (SRD), a first sequence of commands to a first plurality of tag to inventory the first plurality of tags; adjust the first transmission power level of the SRD to a second transmission power level; and transmit, at the second transmission power level of the SRD, a second sequence of inventorying commands to a second plurality of tags to inventory the second plurality of tags.

Aspect 2. The apparatus of Aspect 1, wherein the first sequence of commands includes inventorying commands to inventory the first plurality of tags and the second sequence of commands includes inventorying commands to inventory the second plurality of tags.

Aspect 3. The apparatus of Aspect 2, wherein the at least one processor is configured to: adjust the second transmission power level of the SRD to a third transmission power level, wherein the third transmission power level is associated with a predetermined maximum transmission power level of the SRD; transmit, at the third transmission power level of the SRD, a third sequence of inventorying commands to a third plurality of tags to inventory the third plurality of tags; and determine to terminate inventorying operations of the SRD based on the SRD not detecting additional tags to be inventoried.

Aspect 4. The apparatus of any of Aspects 2 to 3, wherein the at least one processor is configured to: transmit, at the third transmission power level of the SRD, the third sequence of inventorying commands to the third plurality of tags, wherein the third sequence of inventorying commands includes a query with a slot counter value set to prompt reply by tags remaining to be inventoried.

Aspect 5. The apparatus of any of Aspects 2 to 4, wherein the first sequence of commands and the second sequence of commands include a query, and an acknowledgement command (ACK) generated in response to reception of a reply by an tag.

Aspect 6. The apparatus of any of Aspects 2 to 5, wherein the reply by the tag is a 16 digit random number (RN16) reply.

Aspect 7. The apparatus of any of Aspects 2 to 6, wherein the first sequence of commands and the second sequence of commands includes a select command to select a plurality of tags to inventory.

Aspect 8. The apparatus of any of Aspects 2 to 7, wherein the second transmission power level is greater than the first transmission power level.

Aspect 9. The apparatus of any of Aspects 2 to 8, wherein the at least one processor is configured to: adjust the first transmission power level to the second transmission power level periodically.

Aspect 10. The apparatus of any of Aspects 2 to 9, wherein the at least one processor is configured to: adjust the first transmission power level to the second transmission power level based on completion of inventorying each tag of the first plurality of tags.

Aspect 11. The apparatus of any of Aspects 2 to 10, wherein the at least one processor is configured to: determine a change in position of the SRD; and adjust, based on the change in the position of the SRD exceeding a predetermined threshold, the second transmission power level of the SRD to the first transmission power level.

Aspect 12. The apparatus of any of Aspects 2 to 11, wherein the at least one processor is configured to: determine the change in the position exceeds the predetermined threshold based on a distance traveled by the SRD.

Aspect 13. The apparatus of any of Aspects 2 to 12, wherein the at least one processor is configured to: determine the change in the position exceeds the predetermined threshold based on a speed and direction of the SRD from a velocity sensor.

Aspect 14. The apparatus of any of Aspects 2 to 13, wherein the at least one processor is configured to: determine the change in the position exceeds the predetermined threshold based on an absolute position of the SRD from a global positioning system.

Aspect 15. The apparatus of any of Aspects 2 to 14, wherein the first sequence of commands includes access commands to read, write, and kill the first plurality of tags and the second sequence of commands includes access commands to read, write, and kill the second plurality of tags.

Aspect 16. The apparatus of claim of any of Aspects 2 to 15, wherein the first transmission power level is associated with a predetermined maximum transmission power level of the SRD, the first sequence of commands includes a select inventorying command and a query inventorying command, and the at least one processor is configured to: transmit the first sequence of commands periodically to detect additional tags to be inventoried; and determine to terminate inventorying operations of the SRD based on the SRD not detecting additional tags to be inventoried.

Aspect 17. The apparatus of any of Aspects 2 to 16, wherein the at least one processor is configured to: determine, based on a change in position of the SRD, to transmit a third sequence of commands to inventory a third plurality of tags.

Aspect 18. The apparatus of any of Aspects 1 to 17, wherein the SRD is a Radio Frequency Identification (RFID) reader, and wherein the first plurality of tags include a plurality of RFID tags.

Aspect 19. A method for wireless communications, the method comprising: transmitting, at a first transmission power level of a short range device (SRD), a first sequence of commands to a first plurality of tags to inventory the first plurality of tags; adjusting the first transmission power level of the SRD to a second transmission power level; and transmitting, at the second transmission power level of the SRD, a second sequence of inventorying commands to a second plurality of tags to inventory the second plurality of tags.

Aspect 20. The method of Aspect 19, wherein the first sequence of commands includes inventorying commands to inventory the first plurality of tags and the second sequence of commands includes inventorying commands to inventory the second plurality of tags.

Aspect 21. The method of any of Aspects 19 to 20, further comprising: adjusting the second transmission power level of the SRD to a third transmission power level, wherein the third transmission power level is associated with a predetermined maximum transmission power level of the SRD; transmitting, at the third transmission power level of the SRD, a third sequence of inventorying commands to a third plurality of tags to inventory the third plurality of tags; and determining to terminate inventorying operations of the SRD based on the SRD not detecting additional tags to be inventoried.

Aspect 22. The method of any of Aspects 19 to 21, further comprising: transmitting, at the third transmission power level of the SRD, the third sequence of inventorying commands to the third plurality of tags, wherein the third sequence of inventorying commands includes a query with a slot counter value set to prompt reply by tags remaining to be inventoried.

Aspect 23. The method of any of Aspects 19 to 22, wherein the first sequence of commands and the second sequence of commands include a query, and an acknowledgement command (ACK) generated in response to reception of a reply by an tag.

Aspect 24. The method of any of Aspects 19 to 23, wherein the reply by the tag is a 16 digit random number (RN16) reply.

Aspect 25. The method of any of Aspects 19 to 24, wherein the first sequence of commands and the second sequence of commands includes a select command to select a plurality of tags to inventory.

Aspect 26. The method of any of Aspects 19 to 25, wherein the second transmission power level is greater than the first transmission power level.

Aspect 27. The method of any of Aspects 19 to 26, further comprising: adjusting the first transmission power level to the second transmission power level periodically.

Aspect 28. The method of any of Aspects 19 to 27, further comprising: adjusting the first transmission power level to the second transmission power level based on completion of inventorying each tag of the first plurality of tags.

Aspect 29. The method of any of Aspects 18 to 28, further comprising: determining a change in position of the SRD; and adjusting, based on the change in the position of the SRD exceeding a predetermined threshold, the second transmission power level of the SRD to the first transmission power level.

Aspect 30. The method of any of Aspects 19 to 29, further comprising: determining the change in the position exceeds the predetermined threshold based on a distance traveled by the SRD.

Aspect 31. The method of any of Aspects 19 to 30, further comprising: determining the change in the position exceeds the predetermined threshold based on a speed and direction of the SRD from a velocity sensor.

Aspect 32. The method of any of Aspects 19 to 31, further comprising: determining the change in the position exceeds the predetermined threshold based on an absolute position of the SRD from a global positioning system.

Aspect 33. The method of any of Aspects 19 to 32, wherein the first sequence of commands includes access commands to read, write, and kill the first plurality of tags and the second sequence of commands includes access commands to read, write, and kill the second plurality of tags.

Aspect 34. The method of claim of any of Aspects 19 to 33, wherein the first transmission power level is associated with a predetermined maximum transmission power level of the SRD, the first sequence of commands includes a select inventorying command and a query inventorying command, and the method further comprising: transmitting the first sequence of commands periodically to detect additional tags to be inventoried; and determining to terminate inventorying operations of the SRD based on the SRD not detecting additional tags to be inventoried.

Aspect 35. The method of any of Aspects 19 to 34, further comprising: determining, based on a change in position of the SRD, to transmit a third sequence of commands to inventory a third plurality of tags.

Aspect 36. The method of any of Aspects 19 to 35, wherein the SRD is a Radio Frequency Identification (RFID) reader, and wherein the first plurality of tags include a plurality of RFID tags.

Aspect 37. A non-transitory computer-readable medium having stored thereon instructions that, when executed by at least one processor, cause the at least one processor to perform one or more of operations according to any of Aspects 19 to 36.

Aspect 38. An apparatus for wireless communication, the apparatus comprising one or more means for performing operations according to any of Aspects 19 to 36.

1. An apparatus for wireless communications, the apparatus comprising:
at least one memory; and
at least one processor coupled to the at least one memory and configured to:
transmit, at a first transmission power level of a short range device (SRD), a first sequence of commands to a first plurality of tags to inventory the first plurality of tags;
detect a completion of an inventorying of each tag of the first plurality of tags;
adjust, based on the completion of the inventorying, the first transmission power level of the SRD to a second transmission power level; and
transmit, at the second transmission power level of the SRD, a second sequence of commands to a second plurality of tags to inventory the second plurality of tags.

2. The apparatus of claim 1, wherein the first sequence of commands includes inventorying commands to inventory the first plurality of tags and the second sequence of commands includes inventorying commands to inventory the second plurality of tags.

3. The apparatus of claim 2, wherein the at least one processor is configured to:
adjust the second transmission power level of the SRD to a third transmission power level, wherein the third transmission power level is associated with a predetermined maximum transmission power level of the SRD;
transmit, at the third transmission power level of the SRD, a third sequence of commands to a third plurality of tags to inventory the third plurality of tags; and
determine to terminate inventorying operations of the SRD based on the SRD not detecting additional tags to be inventoried.

4. The apparatus of claim 3, wherein the third sequence of commands includes a query with a slot counter value set to prompt reply by tags remaining to be inventoried.

5. The apparatus of claim 3, wherein the first sequence of commands and the second sequence of commands include a query, and an acknowledgement command (ACK) generated in response to reception of a reply by a tag.

6. The apparatus of claim 5, wherein the reply by the tag is a 16 digit random number (RN16) reply.

7. The apparatus of claim 5, wherein the first sequence of commands and the second sequence of commands includes a select command to select a plurality of tags to inventory.

8. The apparatus of claim 1, wherein the second transmission power level is greater than the first transmission power level.

9. The apparatus of claim 8, wherein the at least one processor is configured to:
adjust the first transmission power level to the second transmission power level periodically.

10. (canceled)

11. The apparatus of claim 1, wherein the at least one processor is configured to:
determine an additional change in position of the SRD; and
adjust, based on the additional change in the position of the SRD exceeding an additional threshold, the second transmission power level of the SRD to the first transmission power level.

12. The apparatus of claim 11, wherein the at least one processor is configured to:
determine that the additional change in the position exceeds the additional threshold based on a distance traveled by the SRD.

13. The apparatus of claim 11, wherein the at least one processor is configured to:
determine that the additional change in the position exceeds the additional threshold based on a speed and direction of the SRD from a velocity sensor.

14. The apparatus of claim 11, wherein the at least one processor is configured to:
determine that the additional change in the position exceeds the additional threshold based on an absolute position of the SRD from a global positioning system.

15. The apparatus of claim 1, wherein the first sequence of commands includes access commands to read, write, and kill the first plurality of tags and the second sequence of commands includes access commands to read, write, and kill the second plurality of tags.

16. The apparatus of claim 1, wherein the first transmission power level is associated with a predetermined maximum transmission power level of the SRD, the first sequence of commands includes a select inventorying command and a query inventorying command, and the at least one processor is configured to:
transmit the first sequence of commands periodically to detect additional tags to be inventoried; and
determine to terminate inventorying operations of the SRD based on the SRD not detecting any additional tags to be inventoried.

17. The apparatus of claim 16, wherein the at least one processor is configured to:
determine, based on an additional change in position of the SRD, to transmit a third sequence of commands to inventory a third plurality of tags.

18. The apparatus of claim 1, wherein the SRD is a Radio Frequency Identification (RFID) reader, and wherein the first plurality of tags include a plurality of RFID tags.

19. A method for wireless communications, the method comprising:
transmitting, at a first transmission power level of a short range device (SRD), a first sequence of commands to a first plurality of tags to inventory the first plurality of tags;
detecting a completion of an inventorying of each tag of the first plurality of tags adjusting, based on the completion of the inventorying, the first transmission power level of the SRD to a second transmission power level; and
transmitting, at the second transmission power level of the SRD, a second sequence of commands to a second plurality of tags to inventory the second plurality of tags.

20. The method of claim 19, wherein the first sequence of commands includes inventorying commands to inventory the first plurality of tags and the second sequence of commands includes inventorying commands to inventory the second plurality of tags.

21. The apparatus of claim 1, wherein the at least one processor is further configured to:
identify, based on a distance traveled by the SRD, a change in position of the SRD from a first position to a second position; and
determine that the change in position exceeds a threshold, wherein adjusting the first transmission power level of the SRD to the second transmission power level is further based on the identified change in position.
